(19) United States
(12) Patent Application Publication
(10) Pub. No.: US 2009/0070673 A1
(43) Pub. Date: Mar. 12, 2009

(54) System and method for presenting multimedia content and application interface

(76) Inventors: Guy Barkan, Arugot (IL); Ido Wiesenberg, Tel Aviv (IL); Ofer Shayo, Ramat Gan (IL)

Correspondence Address: Pearl Cohen Zedek Latzer, LLP, 1500 Broadway, 12th Floor, New York, NY, 10036, US

(21) Appl. No.: 11/896,805

(22) Filed: Sep. 6, 2007

(51) Int. Cl. G06F 3/048

(52) U.S. Cl. 715/716

(57) ABSTRACT

A system and method for presenting multimedia content and at least one application interface. Multiple application graphical user interfaces (GUI) or other graphical objects may be overlayed on multimedia content such as selected video clips. A graphical user interface is provided for managing displayed objects, selecting content to be displayed, manipulating displayed content, and interacting with application interfaces overlayed on the multimedia content. A server may be in communication with a plurality of client computers to authenticate users, gather content consumption data, enable communication or other interaction among users viewing multimedia content.

### BACKGROUND OF THE INVENTION

Advancements in communication technologies, computer networks and the internet expose users to a constantly increasing variety of applications and content. Moreover, the constantly increasing computing power available to users, accompanied by increased storage capacity and display capabilities, enable users to consume and produce content as well as run computer applications like never before. A user in today's computerized environment may run a multiplicity of applications, consume content and produce content all the same time.

In order to execute multiple computer applications simultaneously, users may switch from one application interface to another. For example, a user running an electronic mail program, a chat program, and watching a video clip simultaneously may need to switch to his/her mail program interface when new mail comes in, or switch to the chat program when wishing to send a text message and so on.

Some computer applications or programs, for example multimedia presentation programs, may run in full-screen mode, making it impossible or cumbersome to switch to other programs, for example, by minimizing an application window before switching to another application. A program running in full-screen mode may also hide all other application or program interfaces, thus possibly forcing a user to interact with a single program or application at a given time.

### SUMMARY OF EMBODIMENTS OF THE INVENTION

According to some embodiments of the invention, a novel way for consolidating the interaction with a plurality of computer programs and/or applications is disclosed. According to some embodiments of the invention, program and/or application interfaces may be laid over one another, such rendering and/or presentation may enable a user to interact with a plurality of applications simultaneously, and/or enable a presentation of content and/or information concurrently.

According to some embodiments of the invention, a video clip may be presented to a user in substantially full-screen mode and computer application interfaces may be laid over, or placed on top of the video. Such presentation arrangement may enable a user to interact with a plurality of applications while watching a full-screen video clip, all at the same time. According to some embodiments of the invention, audio, video or other multimedia content selection, manipulation, sharing and/or editing menus may also be placed on top, or laid over a full-screen video display.

### BRIEF DESCRIPTION OF THE DRAWINGS

Embodiments of the invention are illustrated by way of example and not limitation in the figures of the accompanying drawings, in which like reference numerals indicate corresponding, analogous or similar elements, and in which:

FIG. 1 shows exemplary blocks according to some embodiments of the present invention;

FIG. 2 shows exemplary blocks according to some embodiments of the present invention; and

FIG. 3 shows exemplary an exemplary screen layout according to some embodiments of the present invention; and

FIG. 4 shows exemplary an exemplary screen layout according to some embodiments of the present invention.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. For example, “a plurality of stations” may include two or more stations.

Unless explicitly stated, the method embodiments described herein are not constrained to a particular order or sequence. Additionally, some of the described method embodiments or elements thereof can occur or be performed at the same point in time.

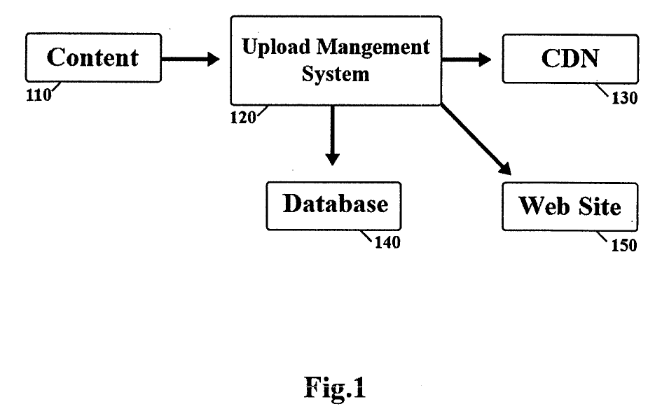

Reference is made to FIG. 1 showing schematic blocks according to some embodiments of the invention. FIG. 1 shows content 110, upload management system 120, content delivery network (CDN) 130, database 140 and Internet website 150. These blocks are described in turn below.

According to some embodiments of the invention, content 110 may be any digital content, such as, but not limited to, text, images, video, audio, multimedia or any combination thereof. According to some embodiments of the invention, content 110 may be privately owned content, such as digital representation of music, pictures, images, graphics, video clips, or movies. Content 110 may possibly be a plurality of digital items, owned by their respective creators or by some other commercial bodies. Alternatively, content 110 may be content that is public domain and/or user-generated, and may further be communicated, delivered and/or manipulated freely. Content 110 may be stored and/or communicated in any suitable format, for example, content 110 may be compressed or encrypted.

As known in the art, content delivery network (CDN) 130 may be a system that delivers, or is capable of delivering content via internet, for example, fee-for-service delivery of content via the internet. For example Akamai (provided by Akamai Technologies, Inc) or Limelight (provided by LIMELIGHT Networks). CDN 130 may comprise multiple, interlinked “edge” servers throughout the internet, which may help reduce network congestion and server overload and may provide content delivery to large numbers of users. Internet web site 150 may represent an exemplary internet web site that may store content and may further provide content to end users. According to some embodiments of the invention, content 110 may be uploaded to a plurality of internet web sites by upload management system 120., Alternatively, management system 120 may only store a unique resource locator (URL), for example, at internet web site 150 or CDN 130, such unique resource locator (URL) may point to content 110, enabling users to retrieve content 110 from its original storage.

According to some embodiments of the invention, upload management system 120 may perform, manage, supervise and coordinate an upload procedure of content 110 to CDN 130 and/or to web site 150. According to some embodiments of the invention, an upload procedure of content 110 may comprise communicating of content 110, and storing of content 110 in CDN 130 and/or web site 150. It should be understood that content 110 may be uploaded to a plurality of internet web sites by system 120 and that internet web site 150 is shown as an exemplary site, additionally, CDN 130 may represent a plurality of physical storage and/or delivery systems.

In some embodiments of the invention, content 110 may be suitable for playing. According to some embodiments of the invention, content 110 may be changed, converted or otherwise manipulated by system 120 prior to being communicated to, and/or stored at, CDN 130 or web site 150. For example, the format of content 110 may be changed or converted. According to some embodiments of the invention, content 110 may be transformed in order to be suitable for presentation or manipulation by a specific computer program such as a multimedia content player. For example, content 110 may be or may be transformed to a format suitable for presentation by a flash player, for example, Flash Player version 9, available from Adobe Systems Incorporated.

According to some embodiments of the invention, an upload procedure may further comprise an upload or an update of a session definition file. A session definition file may be stored within CDN 130, web site 150 or database 140 and may contain details and parameters pertaining to a presentation of content 110. According to some embodiments of the invention, a session definition file may define various aspects pertaining to the presentation of content 110 to users or consumers, as well as various aspects pertaining to the interaction of users and/or consumers with content 110. For example, a session definition file may contain definitions and/or code for menus, such as content selection menus that will be presented to a user, or it may contain definitions and/or code for communicating with a server in order to perform authentication or in order to load additional definition files. A session definition file may be suitable for a specific application used by users and/or consumers of content 110. For example, if consumers of content 110 use flash player in order to view or interact with content 110 then a shockwave flash (SWF) file may serve as a session definition file. According to other embodiments of the invention, other file types may be used as a session definition file, for example, flash video (.flv), shockwave template (.swt) or flashwave component (.swc) files may be used.

According to some embodiments of the invention, an upload procedure may further comprise storing of information pertaining to the uploaded content in database 140. Such storing of information may be performed by upload management system 120. According to some embodiments of the invention, information stored in database 140 may comprise metadata associated with the uploaded content 110. For example, if content 110 comprises music tracks, then the metadata associated with it may comprise genre, artist, album, year, keywords, and the like. Another example of metadata may be a rating associated with content 110 uploaded to CDN 130 or web site 150, for example, uploaded content may be rated as adult content, such rating may be stored by system 120 in database 140 as metadata. Yet another example of metadata may be a popularity rating associated with the content uploaded to CDN 130 or web site 150, for example, most popular, most viewed, most recently viewed, most recently uploaded, etc., which rating may be stored by system 120 in database 140 as metadata.

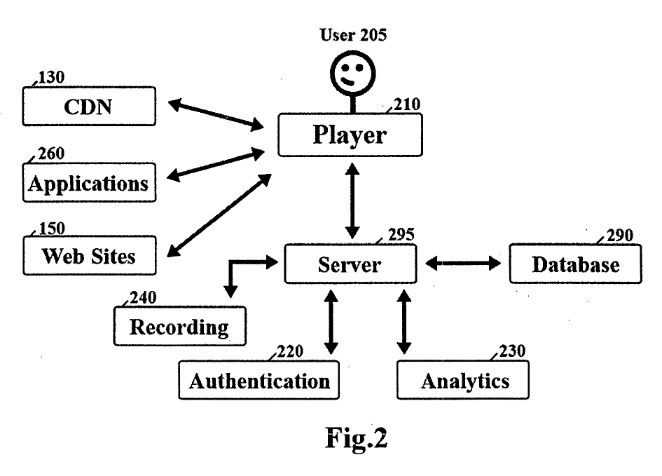

Reference is made to FIG. 2 showing schematic blocks according to some embodiments of the invention. According to some embodiments of the invention, media player 210 may be a computer program operating on a computer, or any other suitable device, operated by user 205. According to some embodiments of the invention, player 210 may be a plug-in. As known in the art, plug-in applications are programs that can easily be installed and used as part of a web browser. Player 210 may further be capable of presenting multimedia content, particularly including video and/or audio content, and possibly other content. According to other embodiments of the invention, player 210 may be an application or a program executed by a device such as, but not limited to, a mobile phone, a smartphone, or a television setupbox. Player 210 may further enable user 205 to interact with the presented content. For example, if the content presented to user 205 is a video clip, then player 210 may provide an interface for actions such as, but not limited to, playing, stopping, pausing, rewinding and fast-forwarding of a video clip. Player 210 may further present various menus or other interaction widgets or graphical objects to user 205. For example, application interfaces may be presented to user 205 by player 210. Such application interfaces or other widgets may be presented to user 205 according to definition and/or code contained in files that may be loaded into player 210.

According to some embodiments of the invention, player 210 may be purchased by end users, or it may be freeware, possibly downloaded from the internet, or it may be otherwise freely provided by some organization, for example, included in the user's computer operating system. For example, according to some embodiments of the invention, player 210 may be flash player, available from Adobe Systems Incorporated. In other embodiments of the invention, player 210 may be other multimedia presentation programs such as Sencesa Free Flash Player 1.5 (provided by Sencesa Group) or Silverlight (provided by Microsoft corporation).

According to some embodiments of the invention, player 210 may be provided with a session definition file as input. For example, if player 210 is flash player, then a Shockwave flash (SWF) file may be used as a session definition file for an execution of player 210. A SWF file may define skins, graphical objects, widgets and program interfaces presented to user 205. For example, a SWF file may contain definitions and/or code to provide user 205 with a graphical user interface that may enable user 205 to rate video clips, to share video clips with other users, to add comments, tags, subtitles or to paste balloon messages to video clips. Other objects that may be defined in a SWF file may be objects or widgets that may enable user 205 to view video clips that may be related to the video clip currently played by player 210. According to some embodiments of the invention, objects presented to user 205 may be presented on top, or laid over, a video clip. For example, menus described earlier, or application interfaces such as, but not limited to, chat, mail, or instant messaging may be presented to user 205 while a video clip, in full-screen mode, is played in the background. According to embodiments of the invention, objects presented to user 205 by player 210 may be defined in a session definition file or may be defined in additional files that may be loaded into player 210. Loading of additional files into player 210 may be done according to definitions stored in a session definition file or may be done according to commands issued to player 210 by server 295.

According to some embodiments of the invention, sever 295 may interact with player 210 as well as perform various operations and procedures related to the operation of player 210. For example, server 295 may command player 210 to load various files. For example, SWF files, containing code and definitions as described earlier, may be loaded by player 210 as a result of a command from server 295.

According to some embodiments of the invention, server 295 may execute authentication procedure 220. An authentication procedure may comprise prompting user 205 for input, for example user name/password combination. In such case, server 295 may command player 210 to prompt user 205 for the necessary input and to further communicate the input provided by user 205 to server 295. Server 295 may then communicate with database 290, for example, in order to retrieve a user name/password combination associated with user 205 and verify the input from user 205.

According to some embodiments of the invention, server 295 may command player 210 to load additional files, for example, additional SWF files. In some embodiments of the invention, following a successful authentication of user 205, server 295 may retrieve a user profile associated with user 205, for example from database 290. Server 295 may further command player 210 to load additional files, possibly according to the user profile retrieved. Such additional files may be stored in database 290. Additional files loaded by player 210 may contain code and definitions for the presentation of additional objects. For example, program interfaces such as mail, instant messaging (IM), or content sharing applications may be defined in separate files that may be loaded by player 210 according to commands received from server 295.

According to some embodiments of the invention, another form of interaction between player 210 and server 295 may be a recording of user actions and/or other events as shown by block 240. In some embodiments of the invention, player 210 may inform server 295 of some or all actions performed by user 205, such actions may be content selections, mouse clicks, applications activations, text entered or any other interaction with player 210 performed by user 205. According to some embodiments of the invention, server 295 may use such information as input to analytics process 230. Analytics process may use such input information in order to model user 205. For example, a user model may comprise user preferences, such as preferred music, or other content types, interest in specific products, activity hours, preferred applications and so on. A user model may be used by server 295 in order to provide user 205 with specific, personalized content offerings. Other uses for recorded information by server 295 may be personalization, such as directed advertising, billing and/or surveillance. According to some embodiments of the invention, recording process 240 may store recorded information and other relevant data in database 290.

According to some embodiments of the invention, server 295 may use metadata stored in database 290 in order to locate content that may best suit user's 205 preferences. Such metadata possibly stored in database 290 by upload system 120 as shown in FIG. 1. For example, analytics process 230 may identify that user 205 prefers a specific genre of music, in such case, server 295 may search for music of that genre and command player 210 to offer user 205 to listen and/or purchase music of that genre. According to some embodiments of the invention, in order to control player 205, server 295 may compile SWF files containing specific objects, content or interfaces and further command player 205 to load these files.

It should be understood that sever 295 may, and typically does, communicate with many player 210. According to some embodiments of the invention, server 295 may enable users to communicate. Such communication may comprise sharing of content, synchronize content display and or share comments regarding the content being presented on their respective displays. For example, two or more users, possibly in separate locations may watch the same video clip at the same time. According to some embodiments of the invention, server 295 may command the respective players of all participating users 205 to present the same content simultaneously, creating a common presentation session. Users may further add comments as the content is being displayed, such comments may be communicated by player 210 to server 295 and in turn from server 295 to all players participating in the session. According to some embodiments of the invention, users 205 may share play lists, tags, annotations, content ratings, or free text. In some embodiments of the invention, such tags, annotations, or other text may be associated with a time or a range of time in the multimedia presentation, such that another user viewing the content is presented with the tag, annotation or other text at the desired time. According to some embodiments of the invention, such sharing may be accomplished by communicating shared information to server 295 by a player 210 and by further, communicating the information to multiple players 210 by server 295.

According to some embodiments of the invention, database 290 may contain information and/or parameters such as, but not limited to, user definitions, user/password combinations user profiles and content metadata. A user profile stored in database 290 may contain user preferences, for example, user internet surfing preferences such as, but not limited to, internet sites frequently visited, content type consumed and the like. Other user related information stored in database 290 may be a list of objects, widgets, program interfaces and/or menus to load into player 210. According to some embodiments of the invention, database 290 may further contain metadata pertaining to data stored in CDN 130 and/or web site 150 as described earlier. According to some embodiments of the invention, database 290 may further be used in order to store parameters and information captured, collected and/or produced by player 210 and/or procedures or processes invoked by player 210.

According to some embodiments of the invention, CDN 130 and/or web site 150 may be accessed by player 210, or by programs invoked by player 210. For example, CDN 130 and/or web site 150 may be accessed in order to download or upload content such as, but not limited to, video clips, mail, chat and/or instant messaging text. According to some embodiments of the invention, a definition file such as a SWF may contain references to CDN 130 or web site 150. Such references may further be contained within selection menu items defined in the session definition file and consequently, presented to user 205.

According to some embodiments of the invention, player 210 may communicate with applications 260 on behalf of user 205. Definitions and code for presenting applications 260 interfaces to user 205 by player 210 may be contained, for example, in a SWF file or in SWF files downloaded by player 210 according to definitions in an input SWF file or according to commands received from server 295. According to other embodiments of the invention, a session definition file may contain a list of add-ons. As known in the art, add-ons may refer to entities that may complement, or add functionality to, an existing product or application. According to some embodiments of the invention, add-ons containing interface code and definitions for applications 260 may be loaded by player 210, possibly according to commands received from server 295. According to some embodiments of the invention, add-ons may be contained in SWF files.

According to some embodiments of the invention, applications 260 may be any suitable applications such as but not limited to mail, chat, instant messaging, databases interface engines or search engines. Player 210 may present user 205 with interface objects for interfacing with such applications. Such interface objects may be objects suitable for rendering by player 210 and may further employ application program interfaces (APIs) in order to communicate with applications 260. Player 210 may communicate with applications 260 over any suitable communication medium such as, but not limited to, a local network, the internet, or any other suitable communication medium.

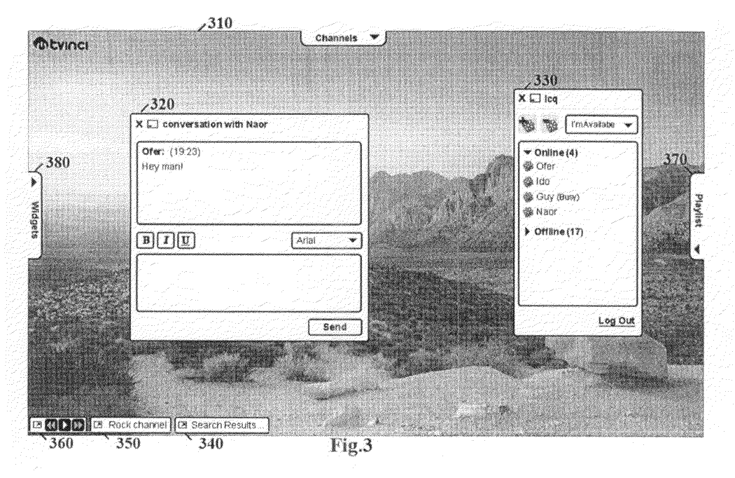

Reference is made to FIG. 3 showing an exemplary screen layout according to some embodiments of the invention. As shown, a full-screen video clip (310) may be played in the background while various objects are displayed over it. Objects 320 and 330 may be interface objects of an instant messaging (IM) application such as ICQ. It should be noted that a user may interact with objects 320 and 330 while video clip 310 is being played. According to some embodiments of the invention, some objects may be minimized, for example, search results (340) may be an application interface or a web browser where a search is being conducted. Object 350 may be a selection menu, for example, object 350 may enable a user to select an audio channel. Object 360 may provide a user with the ability to control the presentation of the video clip played in the background (310). According to some embodiments of the invention, various lists from which a user may select content may be displayed, over a video clip, to a user. Play list (370), shown minimized, may enable a user to select video clips to watch. Object 380 may contain other widgets that may be interacted with by a user.

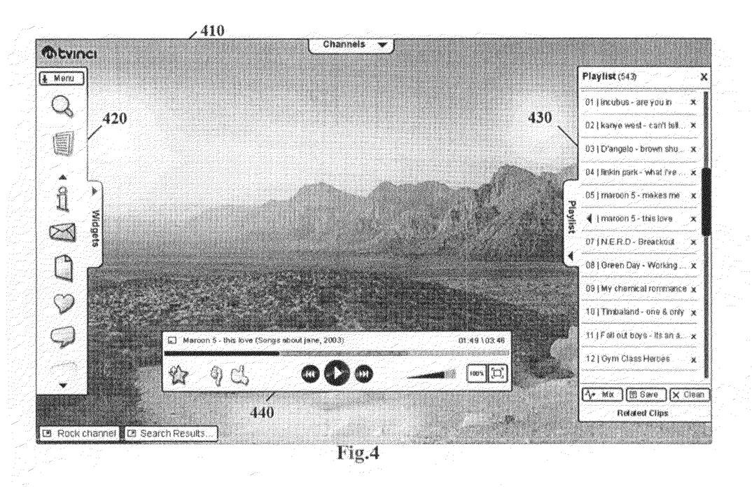

Reference is made to FIG. 4 showing an exemplary screen layout according to some embodiments of the invention. A full-screen video may be presented (410) while various objects, widgets and application interfaces may be laid over it. A menu (420) for launching various application may be presented to a user over the video clip played, such menu may enable a user to launch applications such as, but not limited to, mail, chat, instant messaging, Internet browsing or search. A play list (430) may be presented to a user and may enable a user to select video, audio or other content for presentation, a list may also be saved, clear or shared with other users. A multimedia presentation control object (440) may be presented to a user, enabling a user to control the presentation of the multimedia content being presented. Other than standard operations such as play, stop, pause or fast-forward, a user may annotate the content being presented, share with other users, or tag the content for reference.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. A method comprising:
obtaining a file using an Internet browser program; and
invoking a suitable Internet browser plug-in based on said file;
executing said plug-in according to said file, wherein executing said plug-in results in contemporaneously:
presenting multimedia content on substantially an entire area of a display, and
overlaying at least one program interface on said displayed multimedia content.

2. The method of claim 1, wherein said file is selected from the group consisting of: a Shockwave™ (.swf) file, Flash™ video (.flv) file, Shockwave™ template (.swt) file, or Flashwave™ component (.swc) file.

3. The method of claim 1, wherein said plug-in is file is selected from the group consisting of a Flash™ player, Sencesa™ Flash™ player and Silverlight™ player.

4. The method of claim 1, wherein executing said plug-in according to said file further results in performing a user authentication procedure prior to presenting multimedia content and overlaying said at least one program interface.

5. The method of claim 1, wherein executing said plug-in according to said file further results in transmitting to a remote server data pertaining to interactions of a user with said plug-in.

6. The method of claim 1, wherein said at least one program interface overlayed on said displayed multimedia content is selected from the group consisting of: an email application, an instant messaging application, a chat application, a game application, and a browser application.

7. The method of claim 1, wherein executing said plug-in further results in providing controls for playing said multimedia content, wherein said controls are selected from the group consisting of: playing, pausing, forwarding, reversing, rating, tagging, and annotating, said multimedia content.

8. The method of claim 1, wherein said at least one application interface provides a user with information relating to other users viewing related multimedia content.

9. The method of claim 1, wherein said at least one application interface:
provides a user with information relating to other users viewing the same multimedia content, and
enables a user to synchronize presentation of said multimedia content with at least one of said other users.

10. A computer usable medium having stored thereon a computer-readable file for use in a remote client computer, wherein the computer-readable file when downloaded by the client computer causes the client computer to:
invoke a suitable Internet browser plug-in based on said file;
execute said plug-in according to said file, wherein executing said plug-in causes the client computer to:
present multimedia content on substantially an entire area of a display, and
overlay at least one program interface on said displayed multimedia content.

11. The computer usable medium of claim 10, wherein the computer-readable file is selected from the group consisting of: a Shockwave™ (.swf) file, Flash™ video (.flv) file, Shockwave™ template (.swt) file, or Flashwave™ component (.swc) file.

12. The computer usable medium of claim 10, wherein the computer-readable file is readable using a plug-in player selected from the group consisting of a Flash™ player, Sencesa™ Flash™ player and Silverlight™ player.

13. The computer readable medium of claim 10, wherein executing said plug-in according to said file causes the client computer to perform a user authentication procedure prior to presenting multimedia content and overlaying said at least one program interface.

14. The computer readable medium of claim 10, wherein executing said plug-in according to said file causes the client computer to transmit to a remote server data pertaining to interactions of a user with said plug-in.

15. The computer readable medium of claim 10, wherein said at least one program interface overlayed on said displayed multimedia content is selected from the group consisting of: an email application, an instant messaging application, a chat application, a game application, and a browser application.

16. The computer readable medium of claim 10, wherein executing said plug-in according to said file causes the client computer to provide controls for playing said multimedia content, wherein said controls are selected from the group consisting of: playing, pausing, forwarding, reversing, rating, tagging, and annotating, said multimedia content.

17. The computer readable medium of claim 10, wherein said at least one application interface provides a user with information relating to other users viewing related multimedia content.

18. The computer readable medium of claim 10, wherein said at least one application interface is capable of:
providing a user with information relating to other users viewing the same multimedia content, and
enabling a user to synchronize presentation of said multimedia content with at least one of said other users.

19. A system for presenting multimedia content comprising:
a content delivery system for storing and delivering multimedia content;
a plurality of client computers each having installed thereon an Internet browser program and an Internet browser plug-in suitable for being invoked and executed based on a file, said file being accessible by an Internet browser program, wherein executing said plug-in based on said file results at each client computer in:
presenting multimedia content on substantially an entire area of a display associated with said client computer, said multimedia content delivered by said content delivery system, and
overlaying at least one program interface on said displayed multimedia content; and
a server in communication with each of said client computers for managing presentation of said multimedia content to said plurality of client computers.

20. The system of claim 19 wherein said server is further to coordinate simultaneous presentation of a multimedia content item on at least some of said client computers.

21. The system of claim 19 wherein said server is further to receive and distribute information pertaining to said multimedia content to at least some of said client computers.

22. The system of claim 19 wherein said server is further to authenticate users on said client computers.

23. The system of claim 19 wherein said server is further to model users preferences based, at least in part, on content delivered to users on said client computers.

24. The system of claim 19 wherein said server is further to initiate content delivery and presentation to users on said client computers.
